(19) United States
(12) Patent Application Publication
(10) Pub. No.: US 2017/0255586 A1
(43) Pub. Date: Sep. 7, 2017

(54) DATA PROCESSING SYSTEM AND METHOD FOR OPERATING THE SAME

(71) Applicant: SK hynix Inc., Gyeonggi-do (KR)

(72) Inventor: Nam-Sik JEONG, Gyeonggi-do (KR)

(21) Appl. No.: 15/244,771

(22) Filed: Aug. 23, 2016

(30) Foreign Application Priority Data
Mar. 4, 2016 (KR) 10-2016-0026340

(51) Int. Cl. G06F 13/40; G06F 13/42

(52) U.S. Cl. CPC G06F 13/4068; G06F 13/4282; G06F 2213/0026

(57) ABSTRACT

A data processing system includes: a first memory system including a first memory device and a first controller for controlling the first memory device; a second memory system including a second memory device; a first connector suitable for supporting the first memory system to be coupled with the second memory system through a first connection method; a second connector suitable for supporting the second memory system to be coupled with the first memory system through a second connection method; and a third connector that couples the first memory system and the second memory system with each other.

### CROSS-REFERENCE TO RELATED APPLICATIONS

The present application claims priority under 35 U.S.C. §119(a) to Korean Patent Application. No, 10-2016-0026340, filed on Mar. 4, 2016, which is incorporated herein by reference in its entirety.

### BACKGROUND

1. Field

Exemplary embodiments of the present invention relate generally to a data processing system and, more particularly, to a data processing system for processing data exchanged among a plurality of memory systems, and a method for operating the data processing system.

2. Description of the Related Art

The computer environment paradigm has shifted to ubiquitous computing systems that can be used anywhere and at any time. Due to this, use of portable electronic devices, such as mobile phones, digital cameras, and notebook computers has rapidly increased. These portable electronic devices generally use a memory system having one or more semiconductor memory devices as a data storage for storing data. Memory systems may be used as main or auxiliary memory devices of portable electronic devices.

Memory systems using semiconductor memory devices provide excellent stability, durability, high information access speed, and low power consumption, since they have no moving parts. Examples of memory systems having such advantages include universal serial bus (USB) memory devices, memory cards having various interfaces, and solid state drives (SSD).

### SUMMARY

Embodiments of the present invention are directed to a data processing system that may process data exchanged among a plurality of memory systems more stably and rapidly and to a method for operating the data processing system.

In accordance with an embodiment of the present invention, a data processing system, may include: a first memory system including a first memory device and a first controller for controlling the first memory device; a second memory system including a second memory device; a first connector suitable for supporting the first memory system to be coupled with the second memory system through a first connection method; a second connector suitable for supporting the second memory system to be coupled with the first memory system through a second connection method; and a third connector that couples the first memory system and the second memory system with each other.

The first connector may be coupled with a host of the first memory system, and the first connector may include a first port including a plurality of first pins for connection with the second memory system.

The second connector may include a second port including a plurality of second pins for connection with the first memory system.

The first port may be coupled with the second port through mapping between the first pins and the second pins, and the first pins may transmit/receive signals to/from the second pins through the third connector.

Power pins, ground pins, transmitting pins, reception pins, clock pins, and reset pins of the first pins may be mapped to the corresponding power pins, ground pins, transmitting pins, reception pins, clock pins, and reset pins of the second pins.

As reference dock pins of the first pins may be mapped to reference clock pins of the second pins the first port and the second port are synchronized.

The first connector may be a Peripheral Component Interconnection express (PCIe) connector.

The second connector may be at least one of a Universal Serial Bus (USB) connector and an external Nonvolatile Memory express (NVMe) connector.

The third connector may include a Printed Circuit Board (PCB) pattern or cable; and the cable may be one between a passive-type cable and an active-type cable including an active Integrated Circuit (IC).

The second connector may be inserted into the first connector, and the first memory system and the second memory system are coupled with each other.

The second memory system may further include: a second controller for controlling the second memory device.

In accordance with another embodiment of the present invention, a method for operating a data processing system, may include: coupling a first memory system including a first memory device and a first controller for controlling the first memory device, with a second memory system including a second memory device, through a transmit connector; checking a first connection method of the first memory system and a second connection method of the second memory system; coupling a first connector having the first connection method with a second connector having the second connection method; and transmitting data stored in the first memory system to the second memory system, transmitting data stored in the second memory system to the first memory system, and processing the data transmitted from the first memory system and the second memory system.

The first connector may be coupled with a host of the first memory system, and the first connector may include a first port including a plurality of first pins for connection with the second memory system.

The second connector may include a second port including a plurality of second pins for connection with the first memory system.

The coupling of the first connector having the first connection method with the second connector having the second connection method, the first port and the second port may be coupled with each other through mapping between the first pins and the second pins; and in the transmitting of the data stored in the first memory system to the second memory system, the transmitting of the data stored in the second memory system to the first memory system, and the processing of the data transmitted from the first memory system and the second memory system, the first pins and the second pins may transmit/receive signals through the transmit connector.

Power pins, ground pins, transmitting pins, reception pins, clock pins, and reset pins of the first pins may be mapped to the corresponding power pins, ground pins, transmitting pins, reception pins, clock pins, and reset pins of the second pins.

As reference clock pins of the first pins may be mapped to reference clock pins of the second pins the first port and the second port are synchronized.

The first connector may be a Peripheral Component Interconnection express (PCIe) connector.

The second connector may be at least one of a Universal Serial Bus (USB) connector and an external Non-Volatile Memory express (NVMe) connector.

The transmit connector may include a Printed Circuit Board (PCB) pattern or cable, and the cable may be one between a passive-type cable and an active-type cable including an active Integrated Circuit (IC).

### BRIEF DESCRIPTION OF THE DRAWINGS

The above and other features and advantages of the present invention will become more apparent to those skilled in the art to which the present invention belongs by describing in detail various embodiments thereof with reference to the attached drawings in which:

FIG. 1 is a diagram illustrating a data processing system including a memory system, according to an embodiment of the present invention.

FIG. 2 is a diagram illustrating a memory device, according to an embodiment of the present invention.

FIG. 3 is a circuit diagram illustrating a memory block in a memory device, according to an embodiment of the present invention.

FIGS. 4 to 11 are diagrams schematically illustrating various aspects of the memory device shown in FIG. 2, according to embodiments of the present invention.

FIGS. 12 to 17 conceptually illustrate a data processing system for processing data exchanged among a plurality of memory systems according to an embodiment of the present invention.

FIG. 18 is a flowchart illustrating an operation of processing data in a data processing system according to an embodiment of the present invention.

### DETAILED DESCRIPTION

Exemplary embodiments of the present invention will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the present invention to those skilled in the art.

It will be understood that, although the terms “first”, “second”, “third,” and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and in some instances, proportions may have been exaggerated in order to more clearly illustrate the various elements of the embodiments. For example, in the drawings, the size of elements and the intervals between elements may be exaggerated compared to actual sizes and intervals for convenience of illustration.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention.

As used herein, singular forms are intended to include the plural forms as well, unless the context clearly indicates otherwise.

It will be further understood that the terms “comprises”, “comprising”, “includes”, and “including” when used in this specification, specify the presence of the stated elements and do not preclude the presence or addition of one or more other elements. As used herein, the term “and/or” includes any and all combinations of one or more of the associated listed items.

In the following description, numerous specific details are set forth in order to provide a thorough understanding of the present invention. The present invention may be practiced without some or all of these specific details. In other instances, well known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

Hereinafter, the various embodiments of the present invention will be described in detail with reference to the attached drawings.

Throughout the disclosure, like reference numerals refer to like parts throughout the various figures and embodiments of the present invention.

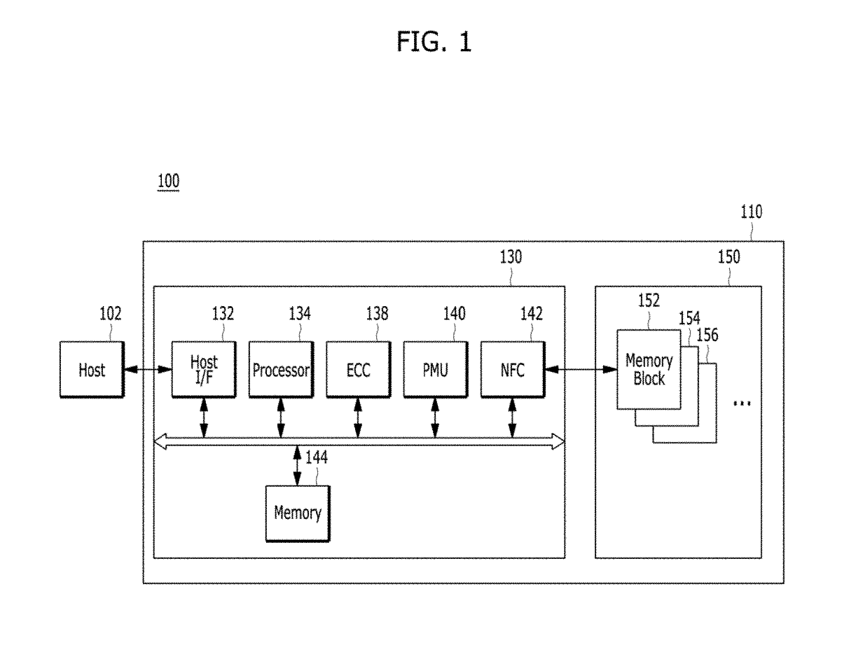

Referring now to FIG. 1 a data processing system 100 is provided, according to an embodiment of the present invention. The data processing system 100 may include a host 102 and a memory system 110.

The host 102 may be or include any suitable electronic device. For example, the host 102 may be or include a portable electronic device, such as a mobile phone, an MP3 player, a laptop computer and the like. The host 102 may include a non-portable electronic device, such as, a desktop computer, a game player, a television (TV), a projector and the like.

The memory system 110 may store data to be accessed by the host 102 in response to a request from the host 102. The memory system 110 may be used as a main memory system or an auxiliary memory system of the host 102. The memory system 110 may be implemented to be coupled electrically with the host 102, according to a protocol of a host interface. The memory system 110 may include one or more semiconductor memory devices. The semiconductor memory devices may, for example, be volatile memory devices. The semiconductor memory devices may, for example, be nonvolatile memory devices. In an embodiment, the memory system 110 may be implemented as a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be or include a volatile memory device, such as, a dynamic random access memory (DRAM), a static random access memory (SRAM) and the like. The storage devices for the memory system 110 may be or include a nonvolatile memory device, such as, a read only memory (ROM) a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM), a resistive RAM (RRAM) and the like.

The memory system 110 may include a memory device 150 for storing data and a controller 130 for controlling data exchange with the memory device 150 and the host 102. For example, under the control of the controller 130 data received from the host may be stored in the memory device 150. Also, the stored data in the memory device 150 may be accessed by the host 102.

The controller 130 and the memory device 150 may be integrated into a single semiconductor device. For instance, the controller 130 and the memory device 150 may be integrated into a semiconductor device configured as a solid state drive (SSD). Configuring the memory system 110 as a SSD, may generally allow a significant increase in an operation speed of the host 102.

The controller 130 and the memory device 150 may be integrated into a semiconductor device configured as a memory card, such as a Personal Computer Memory Card International Association (PCMCIA) card, a compact flash (CF) card, a smart media (SM) card (SMC), a memory stick, a multimedia card (MMC), an RS-MMC and a micro-MMC, a secure digital (SD) card a mini-SD, a micro-SD and an SDHC, a universal flash storage (UFS) device and the like.

Also, the memory system 110 may be or include a computer, an ultra-mobile PC (UMPC), a workstation, a net-book, a personal digital assistant (PDA), a portable computer, a web tablet, a tablet computer, a wireless phone a mobile phone, a smart phone an e-book, a portable multimedia player (PMP), a portable game player, a navigation device a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID device, one of various component elements configuring a computing system and the like.

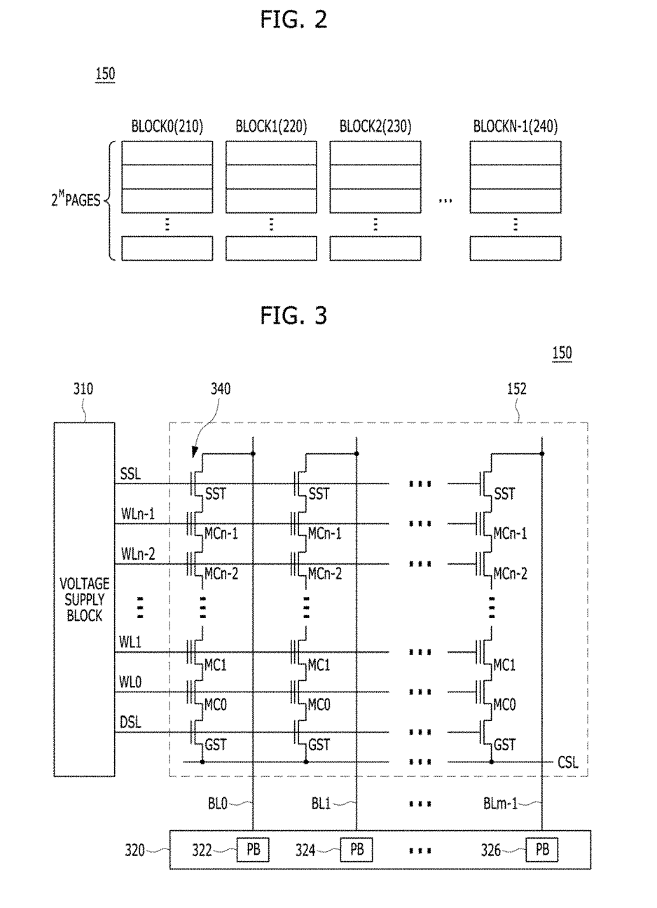

During a write operation, the memory device 150 may store data provided from the host 102. During a read operation, the memory device 150 may provide the stored data to the host 102. One or more memory devices 150 may be employed. The one or more memory devices 150 may be substantially identical. The one or more memory devices may be different memory devices. The memory device 150 may include one or more memory blocks 152, 154 and 156. Each of the memory blocks 152, 154 and 156 may include a plurality of pages. Each page may include a plurality of memory cells coupled electrically to a word line (WL). Each page may include a plurality of memory cells coupled to a plurality of word lines (WL). The memory cells may be single bit cells or multi-bit cells. The plurality of memory cells may be arranged in a two dimensional array. The plurality of memory cells may be arranged in a three dimensional stacked structure. The memory device 150 may be a nonvolatile memory device capable of retaining stored data even when a power supply is interrupted or turned off. According to an embodiment, the memory device may be a flash memory. The memory device may be a flash memory device having a three-dimensional (3D) stack structure. Examples of a non-volatile memory device 150 having a three-dimensional (3D) stack structure are described later herein with reference to FIGS. 2 to 11.

The controller 130 may control the overall operation of the memory device 150, such as read, write, program and/or erase operations. Generally, the controller 130 may control the memory device 150 in response to a request from the host 102. For example, the controller 130 may provide data read from the memory device 150, to the host 102, in response to a read request from the host 102. Also, the controller 130 may store data provided from the host 102 into the memory device 150 in response to a write request.

Any suitable controller may be used. For example, the controller 130 may include a host interface unit 132, a processor 134, an error correction code (ECC) unit 138, a power management unit (PMU) 140, a NAND flash controller (NFC) 142, and a memory 144.

The host interface unit 132 may process commands and/or data provided from the host 102. The host interface unit 132 may communicate with the host 102 through at least one of various interface protocols, such as a universal serial bus (USB), a multimedia card (MMC), a peripheral component interconnect-express (PCI-E), a serial attached SCSI (SAS), a serial advanced technology attachment (SATA), a parallel advanced technology attachment (PATA), a small computer system interface (SCSI), an enhanced small disk interface (ESDI), integrated drive electronics (IDE) and the like. The host interface unit 132 may include any suitable circuits, systems or devices suitable for communicating with the host 102 and the other components of the controller 130 as may be needed.

The ECC unit 138 may detect and correct errors of the data read from the memory device 150 during a read operation. Various detection and correction techniques may be employed. For example, if the number of the error bits detected by the ECC unit 138 is greater than or equal to a threshold number of correctable error bits, the ECC unit 138 may not correct the error bits and output an error correction fail signal indicating failure in correcting the error bits.

The ECC unit 138 may perform an error correction operation based on any suitable error correction scheme. For example, the ECC unit 138 may perform an error correction operation based on a coded modulation scheme among many well-known coded modulation schemes, such as, a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and the like. The ECC unit 138 may include any suitable circuits, systems or devices required for an error detection and correction operation.

The PMU 140 may provide and manage electric power for the controller 130. For example, the PMU 140 may provide and manage electric power for the various components of the controller 130 as may be needed. The PMU 140 may include any suitable circuits, systems and devices.

The NFC 142 is an example of a memory interface between the controller and the memory device 150 when the memory device is a flash memory. The NFC 142 may serve as a memory interface between the controller 130 and the memory device 150 for allowing the controller 130 to control the memory device 150 in response to a request from the host 102. For example, the NFC 142 may generate control signals for the memory device 150. For example, the NFC 142 may process data under the control of the processor 134. Any other suitable memory interface may also be used depending upon the particular memory device employed.

The memory 144 may serve as a working memory of the memory system 110 and the controller 130, and store data for driving the memory system 110 and the controller 130. For example, when the controller 130 controls the operations of the memory device 150, the memory 144 may store data used by the controller 130 and the memory device 150 for such operations as read, write, program and erase operations.

The memory 44 may be or include a volatile memory. For example, the memory 144 may be or include a static random access memory (SRAM) or a dynamic random access memory (DRAM). As described above, the memory 144 may store data used by the host 102 and the memory device 150 for read and/or write operations. The memory 144 may be or include a program memory, a data memory, a write buffer, a read buffer, a map buffer, and the like.

The processor 134 may control the operations of the memory system 110. For example, the processor 134 may control a write operation for the memory device 150, in response to a write request from the host 102. Also, the processor 134 may control a read operation for the memory device 150, in response to a read request from the host 102. The processor 134 may drive a firmware, for example a flash translation layer (FTL), for controlling the general operations of the memory system 110. The processor 134 may, for example, be or include a microprocessor, a central processing unit (CPU) and the like. Any suitable processor may be used.

Other units may also be included in the controller 130. For example, a management unit (not shown) may be included in the processor 134 for performing bad block management of the memory device 150. Accordingly, the management unit may find bad memory blocks included in the memory device 150, i.e., memory blocks which are in an unsatisfactory condition for further use, and perform a bad block management operation the bad memory blocks. For example, when a flash memory, such as a NAND flash memory is employed as the memory device 150, a program failure may occur during a write operation due to inherent characteristics of a NAND logic function. During a bad block management, the data of the program-failed memory blocks (e.g., the bad memory blocks) may be programmed into a new memory block. The bad blocks due to a program fail may seriously deteriorate the utilization efficiency of a memory device, especially one having a 3D stack structure and thus negatively affect the reliability of the memory system 110.

FIG. 2 is a diagram illustrating a memory device 150 according to an embodiment of the present invention.

Referring to FIG. 2 the memory device 150 may include a plurality of memory blocks. For example, the memory device 150 may include zeroth to (N−1)^{th} blocks 210 to 240, where N is a positive integer. Each of the plurality of memory blocks 210 to 240 may include a plurality of pages. For example, each of the plurality of memory blocks 210 to 240 may include 2^{M} number of pages (2^{M} PAGES), where M is a positive integer. Each of the plurality of pages may include a plurality of memory cells to which a plurality of word lines may be coupled electrically. It is noted that any number of suitable blocks and pages per block may be employed.

The memory blocks may be single level cell (SLC) memory blocks and/or multi-level cell (MLC) memory blocks, according to the number of bits which may be stored or expressed in each memory cell. An SLC memory block may include a plurality of pages which are implemented with memory cells each of which is capable of storing 1-bit data. An MLC memory block may include a plurality of pages which are implemented with memory cells each of which is capable of storing multi-bit data (e.g., two or more-bit data). A MLC memory block including a plurality of pages which are implemented with memory cells each of which is capable of storing 3-bit data may be employed and will be referred to as a triple level cell (TLC) memory block.

Each of the plurality of memory blocks 210 to 240 may store data provided from the host 102 during a write operation, and may provide stored data to the host 102 during a read operation.

FIG. 3 is a circuit diagram illustrating a memory block in a memory device according to an embodiment of the present invention.

Referring to FIG. 3, a memory block 152 of the memory device 150 may include a plurality of cell strings 340 coupled electrically to bit lines BL0 to BLm-1, respectively. Each cell string 340 may include at least one drain select transistor DST and at least one source select transistor SST. A plurality of memory cells or a plurality of memory cell transistors MC0 to MCn-1 may be coupled electrically in series between the select transistors DST and SST. The respective memory cells MC0 to MCn-1 may consist of multi-level cells (MLC) each of which stores data information of a plurality of bits. The memory cells MC0 to MCn-1 may have any suitable architecture.

In FIG. 3, ‘DSL’ denotes a drain select line ‘SSL’ denotes a source select line, and ‘CSL’ denotes a common source line.

FIG. 3 shows, as an example, the memory block 152 configured by NAND flash memory cells. It is to be noted, however, that the memory block 152 is not limited to the NAND flash memory cells and may be realized, in other embodiments, by NOR flash memory cells, hybrid flash memory cells having at least two kinds of memory cells combined, or a NAND flash memory cell having a controller built in a memory chip. Also, the operational characteristics of a semiconductor device may be applied to not only a flash memory device in which a charge storing layer is configured by conductive floating gates but also to a charge trap flash (CTF) in which a charge storing layer is configured by a dielectric layer.

It is also noted that the memory device 150 is not limited to a flash memory device only. For example, the memory device 150 may be a DRAM or a SRAM device.

A voltage generator 310 of the memory device 150 may generate voltages, such as a program voltage, a read voltage or a pass voltage, to be supplied to respective word lines according to an operation mode. The voltage generator 310 may generate voltages to be supplied to bulks (e.g., well regions) in which the memory cells are formed. The voltage generator 310 may perform a voltage generating operation under a control of a control circuit (not shown). The voltage generator 310 may generate a plurality of variable read voltages to generate a plurality of read data. The voltage generator 310 may select one of the memory blocks or sectors of a memory cell array, select one of the word lines of the selected memory block, and provide the word line voltages to the selected word line and unselected word lines, under the control of the control circuit.

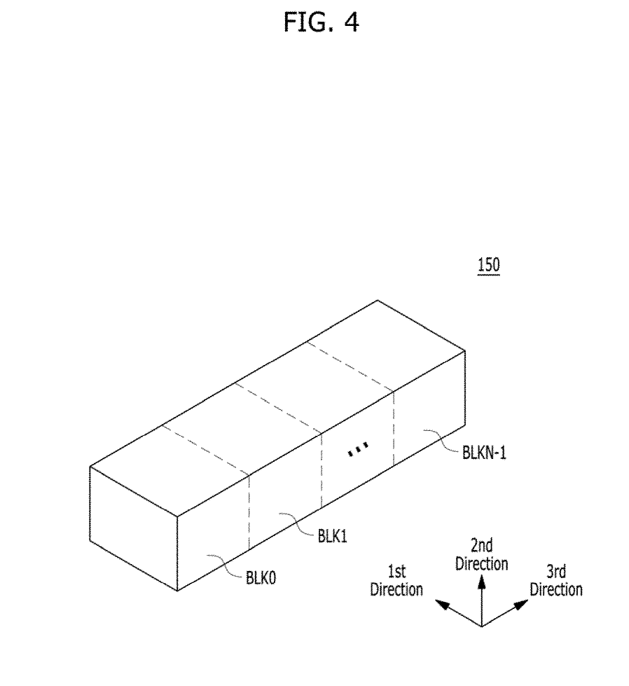

A read/write circuit 320 of the memory device 150 may be controlled by the control circuit, and may serve as a sense amplifier or a write driver according to an operation mode. During a verification/normal read operation, the read/write circuit 320 may serve as a sense amplifier for reading data from the memory cell array. Also, during a program operation, the read/write circuit 320 may serve as a write driver for driving bit lines according to data to be stored in the memory cell array, The read/write circuit 320 may receive data to be written in the memory cell array, from a buffer (not shown), during the program operation, and may drive the bit lines according to the inputted data. To this end, the read/write circuit 320 may include a plurality of page buffers 322, 324 and 326 respectively corresponding to the columns (or bit lines) or pairs of the columns (or pairs of bit lines). Each of the page buffers 322, 324 and 326 may include a plurality of latches (not shown). FIG. 4 is a block diagram illustrating an example of the plurality of memory blocks included in the memory device 150, according to an embodiment of the present invention.

As shown in FIG. 4, the memory device 150 may include a plurality of memory blocks BLK0 to BLKN-1. Each of the memory blocks BLK0 to BLKN-1 may be realized in a 3D structure or a vertical structure. The respective memory blocks BLK0 to BLKN-1 may include a plurality of structures extending in first to third directions (e.g., an x-axis direction, a y-axis direction and a z-axis direction).

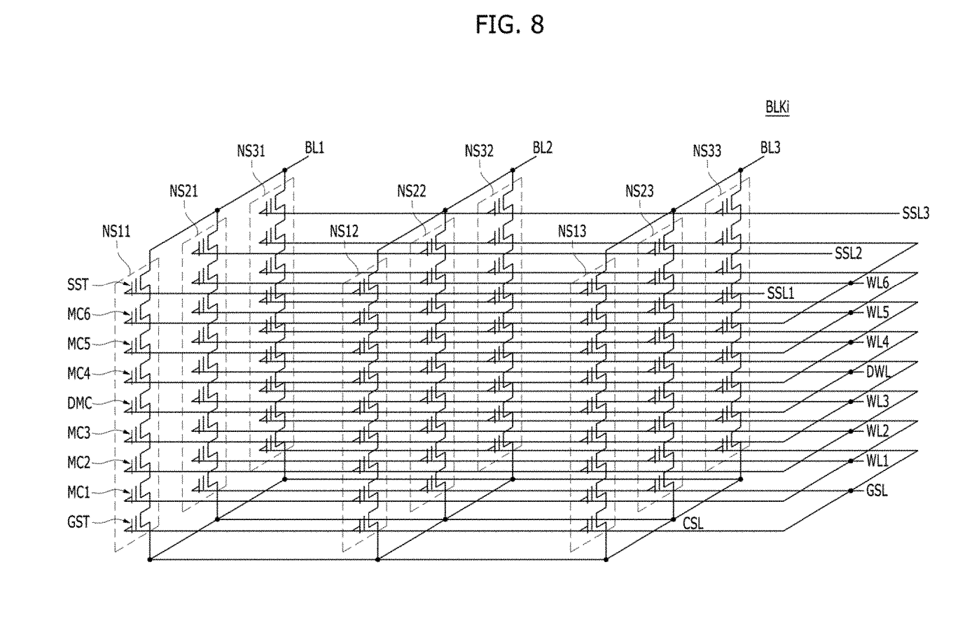

The respective memory blocks BLK0 to BLKN-1 may include a plurality of NAND strings NS extending in the second direction (FIG. 8). The plurality of NAND strings NS may be provided in the first direction and the third direction. Each NAND string NS may be coupled electrically to a bit line BL, at least one source select line SSL, at least one ground select line GSL, a plurality of word lines WL, at least one dummy word line DWL, and a common source line CSL. The respective memory blocks BLK0 to BLKN-1 may be coupled electrically to a plurality of bit lines BL, a plurality of source select lines SSL, a plurality of ground select lines GSL, a plurality of word lines WL, a plurality of dummy word lines DWL, and a plurality of common source lines CSL.

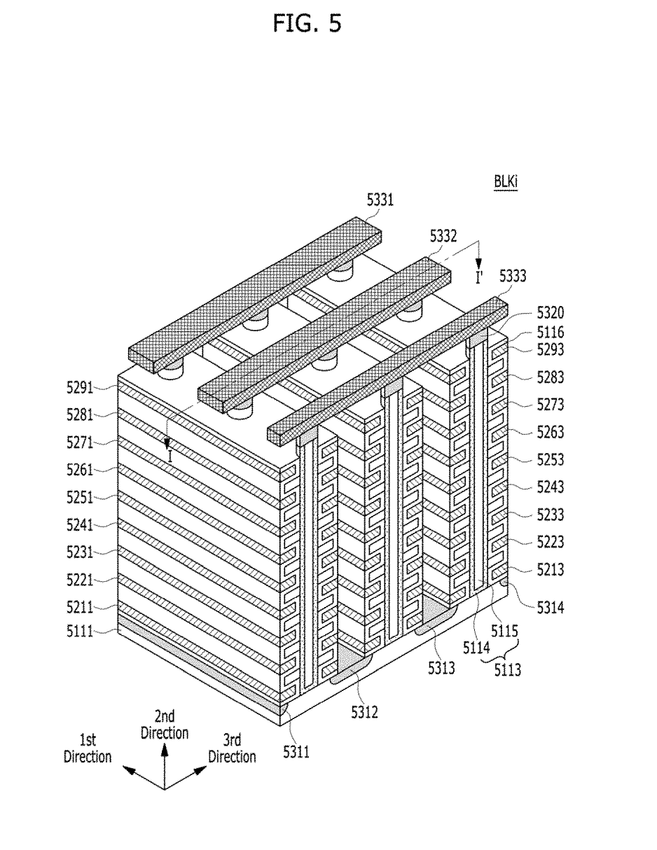

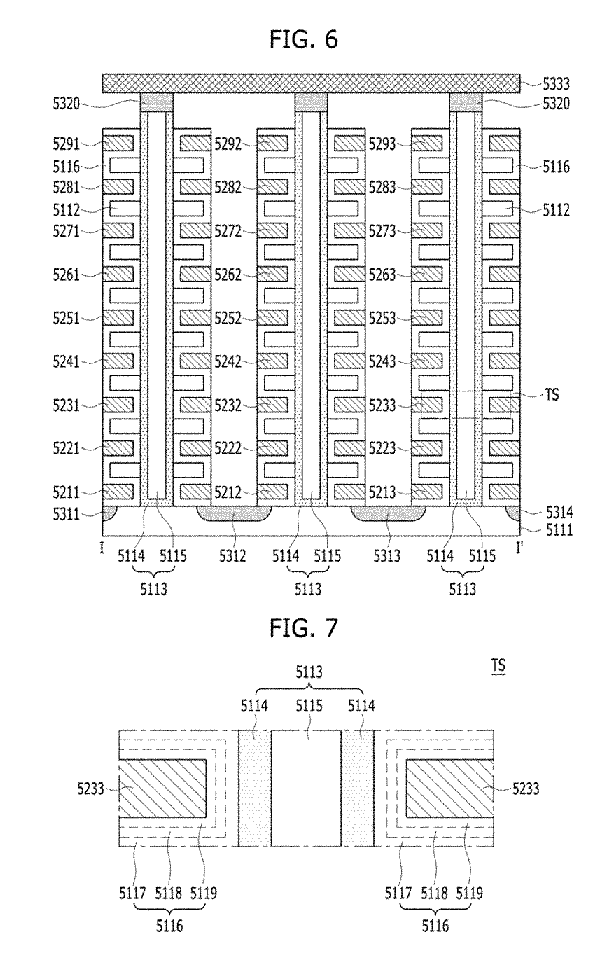

FIG. 5 is a perspective view of one memory block BLKi of the plurality memory blocks BLK0 to BLKN-1 shown in FIG. 4. FIG. 6 is a cross-sectional view taken along a line I-I′ of the memory block BLKi shown in FIG. 5.

Referring to FIGS. 5 and 6, memory block BLKi may include a structure extending in the first to third directions.

The memory block BLKi may include a substrate 5111 including a semiconductor material, such as a silicon material doped with a first type impurity. In another example, the substrate 5111 may include a silicon material doped with a p-type impurity. The substrate 5111 may be a p-type well, for example, a pocket p-well. The substrate 5111 may further include an n-type well surrounding the p-type well. Although, in the embodiment of the present invention, the substrate 5111 is exemplified as being the p-type silicon, it is to be noted that the substrate 5111 is not limited to the p-type silicon and other suitable semiconductor materials may be used.

A plurality of doped regions 5311 to 5314 extending in the first direction may be provided over the substrate 5111. The doped regions 5311 to 5314 are spaced apart at regular intervals in the third direction. The plurality of doped regions 5311 to 5314 may contain a second type impurity that is different from that of the impurity used in the substrate 5111. For example, the plurality of doped regions 5311 to 5314 may be doped with an n-type impurity. Although, in the embodiment of the present invention, first to fourth doped region s 5311 to 5314 are exemplified as being the n-type, it is noted that they are not limited to the n-type.

In the region over the substrate 5111 between the first and second doped regions 5311 and 5312, a plurality of dielectric material regions 5112 extending in the first direction may be spaced apart at regular intervals in the second direction. The dielectric material regions 5112 may also be separated from the substrate 5111 by a preset distance in the second direction. Each of the dielectric material regions 5112 may be separated from one other by a preset distance in the second direction. The dielectric materials 5112 may include any suitable dielectric material, such as, silicon oxide.

In the regions over the substrate 5111 between two consecutive doped regions, for example, between doped regions 5311 and 5312, a plurality of pillars 5113 are spaced apart at regular intervals in the first direction. The plurality of pillars 5113 extend in the second direction and may pass through the dielectric material regions 5112 so that they may be coupled electrically with the substrate 5111. Each pillar 5113 may include one or more materials. For example, each pillar 5113 may include an in inner layer 5115 and an outer surface layer 5114. The surface layer 5114 may include a doped silicon material doped with an impurity. For example, the surface layer 5114 may include a silicon material doped with the same or same type impurity as the substrate 5111. Although, in the present embodiment, the surface layer 5114 is exemplified as including p-type silicon, the surface layer 5114 is not limited to the p-type silicon and other embodiments may readily envisaged by the skilled person wherein the substrate 5111 and the surface layer 5114 of the pillars 5113 may be doped with an n-type impurity.

The inner layer 5115 of each pillar 5113 may be formed of a dielectric material. The inner layer 5115 may be or include a dielectric material, such as, silicon oxide.

In the regions between the first and second doped regions 5311 and 5312, a dielectric layer 5116 may be provided along exposed surfaces of the dielectric material regions 5112, the pillars 5113 and the substrate 5111. A thickness of the dielectric layer 5116 may be less than one half of the distance between the dielectric material regions 5112. In other words, a region of a material other than the dielectric material 5112 and the dielectric layer 5116 may be provided between (i) the dielectric layer 5116 below the bottom surface of a first dielectric material of the dielectric material regions 5112 and (ii) the dielectric layer 5116 provided over the top surface of a second dielectric material of the dielectric material regions 5112. The dielectric material regions 5112 may lie below the first dielectric material.

In the regions between consecutive doped regions, such as in the region between the first and second doped regions 5311 and 5312, a plurality of conductive material regions 5211 to 5291 may be provided over an exposed surface of the dielectric layer 5116. The plurality of the conductive material regions extending in the first direction may be spaced apart at regular intervals in the second direction in an interleaving configuration with the plurality of the dielectric material regions 5112. The dielectric layers 5116 fill the space between the conductive material regions and the dielectric material regions 5112. So for example, the conductive material region 5211 extending in the first direction may be provided between the dielectric material region 5112 adjacent to the substrate 5111 and the substrate 5111. In particular, the conductive material region 5211 extending in the first direction may be provided between (i) the dielectric layer 5116 disposed over the substrate 5111 and (ii) the dielectric layer 5116 disposed below the bottom surface of the dielectric material region 5112 adjacent to the substrate 5111.

Each of the conductive material regions 5211 to 5291 extending in the first direction may be provided between (i) a dielectric layer 5116 disposed over the top surface of one of the dielectric material regions 5112 and (ii) the dielectric layer 5116 disposed below the bottom surface of the next dielectric material region 5112. The conductive material regions 5221 to 5281 extending in the first direction may be provided between the dielectric material regions 5112. The top conductive material region 5291 extending in the first direction may be provided over the uppermost dielectric material 5112. The conductive material regions 5211 to 5291 extending in the first direction may be made of or include a metallic material. The conductive material regions 5211 to 5291 extending in the first direction may be made of or include a conductive material, such as polysilicon.

In the region between the second doped region 5312 and third doped region 5313, the same structures as the structures between the first and second doped regions 5311 and 5312 may be provided. For example, in the region between the second and third doped regions 5312 and 5313, the plurality of dielectric material regions 5112 extending in the first direction, the plurality of pillars 5113 which are sequentially arranged in the first direction and pass through the plurality of dielectric material regions 5112 in the second direction, the dielectric layer 5116 which is provided over the exposed surfaces of the plurality of dielectric material regions 5112 and the plurality of pillars 5113, and the plurality of conductive material regions 5212 to 5292 extending in the first direction may be provided.

In the region between the third doped region 5313 and a fourth doped region 5314, the same structures as between the first and second doped regions 5311 and 5312 may be provided. For example, in the region between the third and fourth doped regions 5313 and 5314, the plurality of dielectric material regions 5112 extending in the first direction, the plurality of pillars 5113 which are sequentially arranged in the first direction and pass through the plurality of dielectric material regions 5112 in the second direction, the dielectric layer 5116 which is provided over the exposed surfaces of the plurality of dielectric material regions 5112 and the plurality of pillars 5113, and the plurality of conductive material regions 5213 to 5293 extending in the first direction may be provided.

Drains 5320 may be respectively provided over the plurality of pillars 5113. The drains 5320 may be made, for example, of silicon materials doped with second type impurities. The drains 5320 may be made of silicon materials doped with n-type impurities. Although for the sake of convenience of explanation, the drains 5320 are exemplified as including n-type silicon, it is noted that the drains 5320 are not limited to the n-type silicon, The width of each drain 5320 may be larger than the width of each corresponding pillar 5113. For example, each drain 5320 may be provided in the shape of a pad over the top surface of each corresponding pillar 5113.

Conductive material regions 53 to 5333 extending in the third direction may be provided over the drains 5320. Each of the conductive material regions 5331 to 5333 may extend in the third direction over drains 5320 which are serially arranged in the third direction. A plurality of conductive material regions 5331 to 5333 extending in the third direction may be spaced apart at a preset separation distance to each other in the first direction. The respective conductive material regions 5331 to 5333 may be coupled electrically with respective drains 5320 therebelow. The drains 5320 and the conductive material regions 5331 to 5333 extending in the third direction may be coupled electrically with through contact plugs. The conductive material regions 5331 to 5333 extending in the third direction may be made of a metallic material. The conductive material regions 5331 to 5333 extending in the third direction may be made of a conductive material, such as, polysilicon.

In FIGS. 5 and 6, the respective pillars 5113 may form strings together with the dielectric layer 5116 and the conductive material regions 5211 to 5291, 5212 to 5292 and 5213 to 5293 extending in the first direction. The respective pillars 5113 may form NAND strings NS together with the dielectric layer 5116 and the conductive material regions 5211 to 5291, 5212 to 5292 and 5213 to 5293 extending in the first direction. Each NAND string NS may include a plurality of transistor structures TS.

Referring now to FIG. 7, in the transistor structure TS shown in FIG. 6, the dielectric layer 5116 may include first to third sub dielectric layers 5117, 5118 and 5119.

The surface layer 5114 of p-type silicon in each of the pillars 5113 may serve as a body. The first sub dielectric layer 5117 adjacent to the pillar 5113 may serve as a tunneling dielectric layer, and may include a thermal oxidation layer.

The second sub dielectric layer 5118 may serve as a charge storing layer, The second sub dielectric layer 5118 may serve as a charge capturing layer, and may include a nitride layer or a metal oxide layer, such as an aluminum oxide layer, a hafnium oxide layer, or the like.

The third sub dielectric layer 5119 adjacent to the conductive material 5233 may serve as a blocking dielectric layer, The third sub dielectric layer 5119 adjacent to the conductive material 5233 extending in the first direction may be formed as a single layer or multiple layers. The third sub dielectric layer 5119 may be a high-k dielectric layer such as an aluminum oxide layer, a hafnium oxide layer, or the like, which has a dielectric constant greater than the first and second sub dielectric layers 5117 and 5118.

The conductive material 5233 may serve as a gate or a control gate. For example, the gate or the control gate 5233, the blocking dielectric layer 5119, the charge storing layer 5118, the tunneling dielectric layer 5117 and the body 5114 may form a transistor or a memory cell transistor structure. For example, the first to third sub dielectric layers 5117 to 5119 may form an oxide-nitride-oxide (ONO) structure. In the embodiment, for the sake of convenience of explanation, the surface layer 5114 of p-type silicon in each of the pillars 5113 will be referred to as a body in the second direction.

The memory block BLKi may include the plurality of pillars 5113. For example, the memory block BLKi may include the plurality of NAND strings NS. In detail, the memory block BLKi may include the plurality of NAND strings NS extending In the second direction or a direction perpendicular to the substrate 5111.

Each NAND string NS may include the plurality of transistor structures TS which are disposed in the second direction. At least one of the plurality of transistor structures TS of each NAND string NS may serve, as a string source transistor SST. At least one of the plurality of transistor structures TS of each NAND string NS may serve as a ground select transistor GST.

The gates or control gates may correspond to the conductive material regions 5211 to 5291, 5212 to 5292 and 5213 to 5293 extending in the first direction. For example, the gates or the control gates may extend in the first direction and form word lines and at least two select lines including at least one source select line SSL and at least one ground select line GSL.

The conductive material regions 5331 to 5333 extending in the third direction may be coupled electrically to one end of the NAND strings NS. The conductive material regions 5331 to 5333 extending in the third direction may serve as bit lines BL. For example, in one memory block BLKi, the plurality of NAND strings NS may be coupled electrically to one-bit line BL.

The second type doped regions 5311 to 5314 extending in the first direction may be provided to the other ends of the NAND strings NS. The second type doped regions 5311 to 5314 extending in the first direction may serve as common source lines CSL.

For example, the memory block BLKi may include a plurality of NAND strings NS extending in a direction perpendicular to the substrate 5111, e.g., the second direction, and may serve as a NAND flash memory block, for example, of a charge capturing type memory, in which the plurality of NAND strings NS are coupled electrically to one-bit line BL.

Although it is illustrated in FIGS. 5 to 7 that the conductive material regions 5211 to 5291, 5212 to 5292 and 5213 to 5293 extending in the first direction are provided by nine (9) layers, it is noted that the conductive material regions 5211 to 5291, 5212 to 5292 and 5213 to 5293 extending in the first direction are not limited thereto. For example, conductive material regions extending in the first direction may be provided in eight (8) layers, sixteen (16) layers or any multiple layers. For example, in one NAND string NS, the number of transistors may be 8, 16 or more.

Although it is illustrated in FIGS. 5 to 7 that three (3) NAND strings NS are coupled electrically to one-bit line BL, it is noted that the embodiment is not limited thereto. In the memory block BLKi, m NAND strings NS may be coupled electrically to one-bit line BL, m being a positive integer. The number of conductive material regions 5211 to 5291, 5212 to 5292 and 5213 to 5293 extending in the first direction and the number of common source lines 5311 to 5314 may be varied with the number of NAND strings NS which are coupled electrically to one-bit line BL.

Further, although it is illustrated in FIGS. 5 to 7 that three (3) NAND strings NS are coupled electrically to one conductive material extending in the first direction, it is noted that the embodiment is not limited thereto. For example, n NAND strings NS may be coupled electrically to one conductive material extending in the first direction, n being a positive integer. The number of bit lines 5331 to 5333 may be varied with the number of NAND strings NS which are coupled electrically to one conductive material extending in the first direction.

Referring to FIG. 8, in a block BLKi having the first structure, a plurality of NAND strings NS11 to NS31 may be provided between a first bit line BL1 and a common source line CSL. The first bit line BL1 may correspond to the conductive material region 5331 of FIGS. 5 and 6, extending in the third direction. NAND strings NS12 to NS32 may be provided between a second bit line BL2 and the common source line CSL. The second bit line BL2 may correspond to the conductive mater al region 5332 of FIGS. 5 and 6, extending in the third direction. NAND strings NS13 to NS33 may be provided between a third bit line BL3 and the common source line CSL. The third bit line BL3 may correspond to the conductive material region 5333 of FIGS. 5 and 6, extending in the third direction.

A source select transistor SST of each NAND string NS may be coupled electrically to a corresponding bit line BL. A ground select transistor GST of each NAND string NS may be coupled electrically to the common source line CSL. Memory cells MC1 and MC6 may be provided between the source select transistor SST and the ground select transistor GST of each NAND string NS.

In this example, the NAND strings NS may be defined by units of rows and columns. The NAND strings NS which are coupled electrically to one-bit line may form one column. The NAND strings NS11 to NS31 which are coupled electrically to the first bit line BL1 may correspond to a first column. The NAND strings NS12 to NS32 which are coupled electrically to the second bit line BL2 may correspond to a second column. The NAND strings NS13 to NS33 which are coupled electrically to the third bit line BL3 may correspond to a third column. The NAND strings NS which are coupled electrically to one source select line SSL may form one row. The NAND strings NS11 to NS13 which are coupled electrically to a first source select line SSL1 may form a first row. The NAND strings NS21 to NS23 which are coupled electrically to a second source select line SSL2 may form a second row. The NAND strings NS31 to NS33 which are coupled electrically to a third source select line SSL3 may form a third row.

In each NAND string NS, a height may be defined. In each NAND string NS, the height of the memory cell MC1 adjacent to the ground select transistor GST may have, for example, a value ‘1’. In each NAND string NS, the height of a memory cell may increase as the memory cell gets closer to the source select transistor SST when measured from the substrate 5111. For example, in each NAND string NS, the height of a memory cell MC6 adjacent to the source select transistor SST may have, for example, a value ‘7’.

The source select transistors SST of the NAND strings NS arranged in the same row may share the source select line SSL. The source select transistors SST of the NAND strings NS arranged in different rows may be respectively coupled electrically to the different source select lines SSL1, SSL2 and SSL3.

The memory cells at the same height in the NAND strings NS in the same row may share a word line WL. For example at the same height, the word lines WL coupled electrically to the memory cells MC of the NAND strings NS in different rows may be coupled electrically with each other. Dummy memory cells DMC at the same height in the NAND strings NS of the same row may share a dummy word line DWL. For example, at the same height or level, the dummy word lines DWL coupled electrically to the dummy memory cells DMC of the NAND strings NS in different rows may be coupled electrically with each other.

The word lines WL or the dummy word lines DWL located at the same level or height or layer may be coupled electrically with each other for each of the layers where the conductive material regions 5211 to 5291, 5212 to 5292 and 5213 to 5293 extending in the first direction may be provided. The conductive material regions 5211 to 5291, 5212 to 5292 and 5213 to 5293 extending in the first direction may be coupled electrically in common to upper layers through contacts. In other words, the ground select transistors GST of the NAND strings NS in the same row may share the ground select line GSL. Further, the ground select transistors GST of the NAND strings NS in different rows may share the ground select line GSL. For example, the NAND strings NS11 to NS13, NS21 to NS23 and NS31 to NS33 may be coupled electrically in common to the ground select line GSL.

The common source line CSL may be coupled electrically in common to the NAND strings NS. Over the active regions >over the substrate 5111, the first to fourth doped regions 5311 to 5314 may be coupled electrically. The first to fourth doped regions 5311 to 5314 may be coupled electrically in common to an upper layer through contacts.

For example, as shown in FIG. 8, the word lines WL of the same height or level may be coupled electrically to each other. Accordingly, when a word line WL at a certain height is selected, all NAND strings NS which are coupled electrically to the selected word line WL may be selected. The NAND strings NS in different rows may be coupled electrically to different source select lines SSL. Accordingly, among the NAND strings NS coupled electrically to the same word line WL, by selecting one of the source select lines SSL1 to SSL3, the NAND strings NS in the unselected rows may be electrically isolated from the bit lines BL1 to BL3. In other words, by selecting one of the source select lines SSL1 to SSL3, the NAND strings NS arranged in the same row as the selected source line may be selected. Furthermore, by selecting one of the bit lines BL1 to BL3, the NAND strings NS arranged in the same column as the selected bit line may be selected. Accordingly, only the NAND strings NS arranged in the same row as the selected source line and the same column as the selected bit line may be selected.

In each NAND string NS, a dummy memory cell DMC may be provided. In FIG. 8 for example, the dummy memory cell DMC may be provided between a third memory cell MC3 and a fourth memory cell MC4 in each NAND string NS. For example, first to third memory cells MC1 to MC3 may be provided between the dummy memory cell DMC and the ground select transistor GST. Fourth to sixth memory cells MC4 to MC6 may be provided between the dummy memory cell DMC and the source select transistor SST. The memory cells MC of each NAND, string NS may be divided into two (2) memory cell groups by the dummy memory cell DMC. In the divided memory cell groups, memory cells, for example, MC1 to MC3, adjacent to the ground select transistor GST may be referred to as a lower memory cell group and remaining memory cells, for example, MC4 to MC6, adjacent to the string select transistor SST may be referred to as an upper memory cell group.

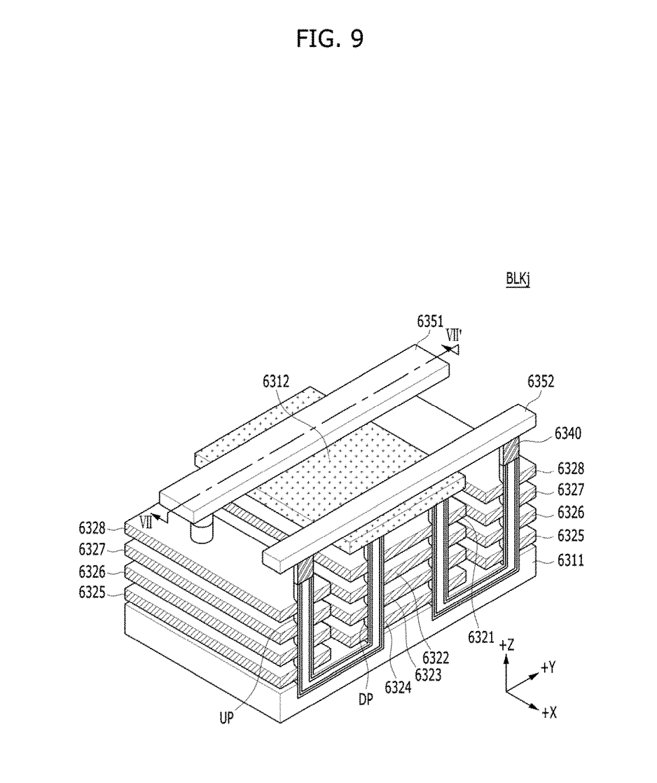

Herein below, detailed descriptions will be made with reference to FIGS. 9 to 11, which show a memory device in a memory system, according to an embodiment implemented with a three-dimensional (3D) nonvolatile memory device different from the first structure.

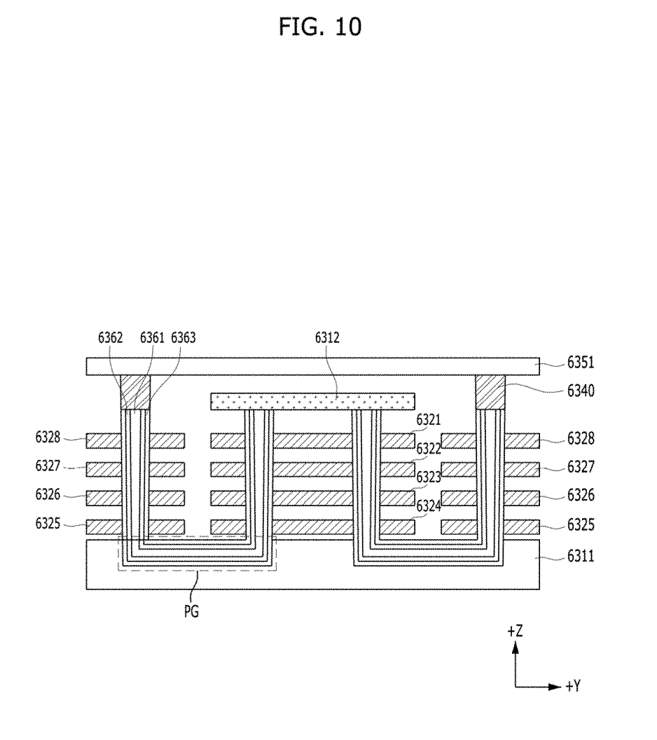

FIG. 9 is a perspective view schematically illustrating a memory device implemented with a three-dimensional (3D) nonvolatile memory device, which is different from the first structure described above with reference to FIGS. 5 to 8 and showing a memory block BLKj of the plurality of memory blocks of FIG. 4. FIG. 10 is a cross-sectional view illustrating the memory block BLKj taken along the line VII-VII′ of FIG. 9.

Referring to FIGS. 9 and 10, the memory block BLKj may include structures extending in the first to third directions and may include a substrate 6311. The substrate 6311 may include a silicon material doped with a first type impurity. For example, the substrate 6311 may include a silicon material doped with a p-type impurity. The substrate 6311 may be a p-type well, for example, a pocket p-well. The substrate 6311 may further include an n-type well which surrounds the p-type well. Although, in the described embodiment, the substrate 6311 is exemplified as being the p-type silicon, it is noted that the substrate 6311 is not limited to the p-type silicon.

First to fourth conductive material regions 6321 to 6324 extending in an x-axis direction and a y-axis direction are provided over the substrate 6311. The first to fourth conductive material regions 6321 to 6324 may be separated by a preset distance in the z-axis direction.

Fifth to eighth conductive material regions 6325 to 6328 extending in the x-axis direction and the y-axis direction may be provided over the substrate 6311. The fifth to eighth conductive material regions 6325 to 6328 may be separated by the preset distance in the z-axis direction. The fifth to eighth conductive material regions 6325 to 6328 may be separated from the first to fourth conductive material regions 6321 to 6324 in the y-axis direction.

A plurality of lower pillars DP passing through the first to fourth conductive material regions 6321 to 6324 may be provided. Each lower pillar DP may extend in the z-axis direction. Also, a plurality of upper pillars UP passing through the fifth to eighth conductive material regions 6325 to 6328 may be provided. Each upper pillar UP may extend in the z-axis direction.

Each of the lower pillars DP and the upper pillars UP may include an internal material 6361, an intermediate layer 6362, and a surface layer 6363. The intermediate layer 6362 may serve as a channel of the cell transistor. The surface layer 6363 may include a blocking dielectric layer, a charge storing layer and a tunneling dielectric layer.

The lower and the upper pillars DP and UP may be coupled electrically with each other through a pipe gate P. The pipe gate PG may be disposed in the substrate 6311. For example, the pipe gate PG may include the same material as the lower pillar DP and the upper pillar UP.

A doping material 6312 of a second type extending in the x-axis direction and the y-axis direction may be provided over the lower pillars DP. For example, the doping material 6312 of the second type may include an n-type silicon material. The doping material 6312 of the second type may serve as a common source line CSL.

Drains 6340 may be provided over the upper pillars UP. The drains 6340 may include an n-type silicon material. First and second upper conductive material regions 6351 and 6352 extending in the y-axis direction may be provided over the drains 6340.

The first and second upper conductive material regions 6351 and 6352 may be spaced apart along the x-axis direction. The first and second upper conductive material regions 6351 and 6352 may be formed of a metal. The first and second upper conductive material regions 6351 and 6352 and the drains 6340 may be coupled electrically with each other through contact plugs. The first and second upper conductive material regions 6351 and 6352 may serve as first and second bit lines BL1 and BL2, respectively.

The first conductive material 6321 may serve as a source select line SSL. The second conductive material 6322 may serve as a first dummy word line DWL1. The third and fourth conductive material regions 6323 and 6324 may serve as first and second main word lines MWL1 and MWL2 respectively. The fifth and sixth conductive material regions 6325 and 6326 may serve as third and fourth main word lines MWL3 and MWL4, respectively. The seventh conductive material 6327 may serve as a second dummy word line DWL2. The eighth conductive material 6328 may serve as a drain select line DSL.

The lower pillar DP and the first to fourth conductive material regions 6321 to 6324 adjacent to the lower pillar DP may form a lower string. The upper pillar UP and the fifth to eighth conductive material regions 6325 to 6328 adjacent to the upper pillar UP may form an upper string. The lower string and the upper string may be coupled electrically with each other through the pipe gate PG. One end of the lower string may be coupled electrically to the doping material 6312 of the second type which serves as the common source line CSL. One end of the upper string may be coupled electrically to a corresponding bit line through the drain 6340. One lower string and one upper string may form one cell string which is coupled electrically between the doping material 6312 serving as the common source line CSL and a corresponding one of the upper conductive material layers 6351 and 6352 serving as the bit line BL.

For example, the lower string may include a source select transistor SST, the first dummy memory cell DMC1, and the first and second main memory cells MMC1 and MMC2. The upper string may include the third and fourth main memory cells MMC3 and MMC4, the second dummy memory cell DMC2, and a drain select transistor DST.

In FIGS. 9 and 10, the upper string and the lower string may form a NAND string NS. The NAND string NS may include a plurality of transistor structures TS. Since the transistor structure included in the NAND string NS in FIGS. 9 and 10 is described above in detail with reference to FIG. 7, a detailed description thereof will be omitted herein.

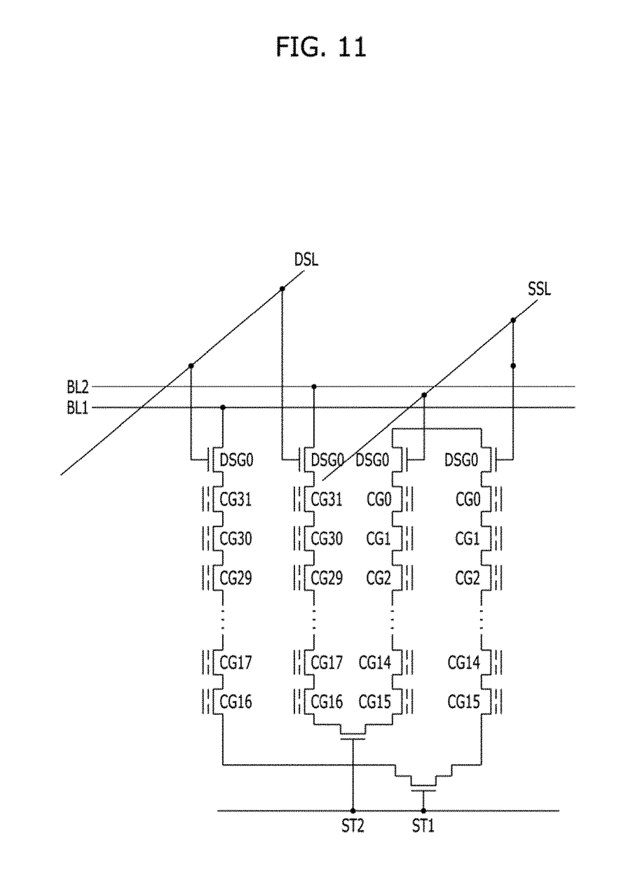

FIG. 11 is a circuit diagram illustrating the equivalent circuit of the memory block BLKj having the second structure as described above with reference to FIGS. 9 and 10. For the sake of convenience, only a first string ST1 and a second string ST2 are shown, forming a pair in the memory block BLKj in the second structure.

Referring to FIG. 11, in the memory block BLKj having the second structure, a plurality of cell strings, each of which is implemented with one upper string and one lower string coupled electrically through the pipe gate PG as described above with reference to FIGS. 9 and 10, may be provided, in such a way as to define a plurality of pairs.

For example, in memory block BLKj having the second structure, memory cells CG0 to CG31 stacked along a first channel CH1 (not shown), for example, at least one source select gate SSG1 and at least one drain select gate DSG1 may form a first string ST1, and memory cells CG0 to CG31 stacked along a second channel CH2 (not shown), for example, at least one source select gate SSG2 and at least one drain select gate DSG2 may form a second string ST2.

The first and the second strings ST1 and ST2 may be coupled electrically to the same drain select line DSL and the same source select line SSL. The first string ST1 may be coupled electrically to a first bit line BL1. The second string ST2 may be coupled electrically to a second bit line BL2. Although FIG. 11 shows the first string ST1 and the second string ST2 are coupled electrically to the same drain select line DSL and the same source select line SSL, it may be envisaged that the first string ST1 and the second string ST2 may be coupled electrically to the same source select line SSL and the same bit line BL, the first string ST1 may be coupled electrically to a first drain select line DSL1 and the second string ST2 may be coupled electrically to a second drain select line DSL2. Further it may be envisaged that the first string ST1 and the second string ST2 may be coupled electrically to the same drain select line DSL and the same bit line BL the first string ST1 may be coupled electrically to a first source select line SSL1 and the second string ST2 may be coupled electrically a second source select line SSL.

Hereafter, the data processing performed between a plurality of memory systems in a data processing system according to an embodiment of the present invention is described in detail. For example, a data transmitting/receiving operation performed among a plurality of memory systems for performing a data read/write operation is described.

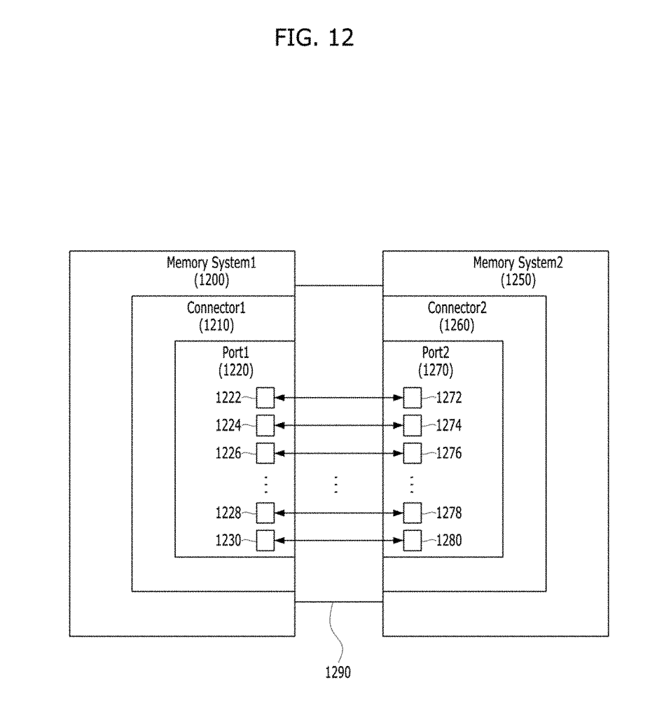

FIGS. 12 to 17 conceptually illustrate a data processing system for processing data exchanged among a plurality of memory systems, according to an embodiment of the present invention. For illustration purposes, an operation of processing data among a plurality of memory systems during a read/write operation in the data processing system including the memory systems 110 described with reference to FIG. 1 is described. In other words, when a read/write operation is performed between a first memory system and a second memory system in a data processing system including a plurality of memory systems, an operation of transmitting/receiving data between the first memory system and the second memory system is described.

Hereafter, for illustration purposes, a case where a first memory system is coupled with a second memory system wherein data stored in the first memory system is transmitted to the second memory system, and also data stored in the second memory system is transmitted to the first memory system is described as an example. Also, in the same example the data which are transmitted to the first memory system and the second memory system is processed in the first memory system and the second memory system respectively, individually. Further in the illustrated embodiment the first memory system which is coupled with the host 102 to realize a data processing system (or a computer system) in FIG. 1, is also coupled with the second memory system. The second memory system may be the memory device 150 of FIG. 1 used as an external device of data processing system (e.g., a computer system). In another example, the second memory system may include both the memory device 150 and the controller 130 of FIG. 1. The data may be transmitted/received between the first memory system and the second memory system.

The data processing system, according to an embodiment of the present invention may be realized as a computer system by including the first memory system realized with the controller 130 and the memory device 150 and the host 102 coupled with the first memory system. Also, the first memory system may be coupled with the second memory system that is an external device of the computer system and may process data by transmitting/receiving to/from the second memory system. Herein, the host 102 coupled with the first memory system may include a connector for operatively coupling the host with the second memory system, whereas the second memory system may include a connector for coupling the second memory system with the first memory system. The connector of the first memory system may be coupled with the connector of the second memory system through corresponding connection schemes appropriate for the first memory system and the second memory system, and the first memory system and the second memory system process data by transmitting/receiving the data.

Herein, as mentioned above, a case where the first memory system includes the memory device 150 and the controller 130 that are shown in FIG. 1 and the first memory system is coupled with the host 102 to realize the data processing system according to the embodiment of the present invention. Hereafter, for illustration purposes, a case where the first memory system is included in a computer system, which is a data processing system, is described as an example. The second memory system may be realized with the memory device 150 or both memory device 150 and controller 130, which is shown in FIG. 1. The second memory system may be coupled with the host 102 along with the first memory system so as to form the data processing system. The realized second memory system may be an external device of the computer system that is realized with the first memory system. Herein, the second memory system may be included in another data processing system that is different from the data processing system including the first memory system. In other words, the second memory system may be included in another computer system that is different from the computer system including the first memory system.

In the following embodiment of the present invention, a case where the first memory system that is coupled with the host 102 and realizes the computer system shown in FIG. 1 is coupled with the second memory system that is realized with the memory device 150 alone or both memory device 150 and controller 130 as shown in FIG. 1, and data are transmitted/received between the first memory system and the second memory system is described in detail.

Referring now to FIG. 12, a data processing system includes a first memory system 1200 and a second memory system 1250. The first memory system 1200 includes the memory device 150 and the controller 130 (see FIG. 1) and is coupled with the host 102. The second memory system 1250 may include the memory device 150, or may include the memory device 150 and the controller 130. The second memory system 1250 is also coupled with the host 102. In the data processing system, the first memory system 1200 which is coupled with the host 102 also includes a first connector 1210 for coupling with the second memory system 1250. The second memory system 1250 includes a second connector 1260 for coupling with the first memory system 1200. The data processing system includes a third connector 1290 for connecting the first connector 1210 of the first memory system 1200 with the second connector 1260 of the second memory system 1250.

To take an example, the first memory system 1200 includes the memory device 150 and the controller 130 illustrated in FIG. 1 and the first memory system 1200 is coupled with the host 102 to realize the computer system. The first memory system 1200 includes the first connector 1210 for the connection with the second memory system 1250. In this example, the first memory system 1200 is coupled with the second memory system 1250, which is an external device of the computer system, through a first method, which may be a Peripheral Component Interconnection express (PCIe). In other words, the first connector 1210 of the first memory system 1200 is coupled with the second memory system 1250, which is the external device, through the first method. The first connector 1210 includes a first port 1220, which supports the connection between the first memory system 1200 and the second memory system 1250 through the first method and connects the first memory system 1200 and the second memory system 1250 with each other. The first port 1220 includes a plurality of first pins 1222, 1224, 1226, 1228 and 1230 for transmitting/receiving data to/from the second memory system 1250 that is coupled with the first memory system 1200 through the first method.

The second memory system 1250 is an external device of the computer system which includes the first memory system 1200. The second memory system 1250 may be realized with the memory device 150 alone or with both of the memory device 150 and the controller 130 illustrated in FIG. 1. The second memory system 1250 includes the second connector 1260 for the connection with the first memory system 1200. Herein the second memory system 1250 is coupled with the computer system through a second method. In other words, the second connector 1260 included in the second memory system 1250 is coupled with the first memory system 1200 of the computer system through the second method, which may be a Universal Serial Bus (USB). The second connector 1260 includes a second port 1270, which includes a plurality of second pins 1272, 1274, 1276, 1278 and 1280 for transmitting/receiving data to/from the first memory system 1200 through the second method. Also, since the second memory system 1250 is coupled with the computer system through USB, the data storage device included in the second memory system 1250, which is a memory device, may be a USB memory device.

Also, the third connector 1290 that couples the first connector 1210 of the first memory system 1200 with the second connector 1260 of the second memory system 1250 couples the first port 1220 of the first connector 1210 that is coupled with the external device through the first method, which is the PCIe, with the second port 1270 of the second connector 1260 that is coupled with the first memory system 1200 of the computer system through the second method, which is the USB. Herein, the third connector 1290 provides a passage for the data transmitted/received between the first pins 1222, 1224, 1226, 1228 and 1230 included in the first port 1220 of the first connector 1210 and the second pins 1272, 1274, 1276, 1278 and 1280 included in the second port 1270 of the second connector 1260. Herein, the third connector 1290 maps and couples the first pins 1222, 1224, 1226, 1228 and 1230 to and with the corresponding second pins 1272, 1274, 1276, 1278 and 1280, respectively.

For example, when the first connector 1210 of the first memory system 1200 is a PCIe connector, the first port 1220 includes the first pins 1222, 1224, 1226, 1228 and 1230 for the connection with the external device, which is the second memory system 1250, through the PCIe. Herein, the first port 1220 of the first connector 1210, which is the PCIe connector, may include a plurality of the first pins 1222, 1224, 1226, 1228 and 1230 as at least 9 pins: two ground pins GNB for ground connection; a power pin for power supply; two reception pins RX− and RX+ for signal reception; two transmitting pins TX− and TX+ for signal transmitting; a reset pin PERST# for connection and access reset; and a clock request pin CLKREQ# for requesting for a dock. The first port 1220 may further include two reference dock pins REFCLK− and REFCLK+, and an additional ground pin GND.

Herein, the first memory system 1200 may transmit data through the first port 1220 of the first connector 1210, which is the PCIe connector. For example, the first memory system 1200 may transmit data at a data rate of about 8 Gbps through the first port 1220 of the first connector 1210, which is the PCIe connector. Also, the first pins 1222, 1224, 1226, . . . 1228 and 1230 of the first connector 1210 may include 18 pins, hereinafter referred to as pins A1 to A18 or 36 pins hereinafter referred to as pins A1 to A18 and B1 to B18. At least some of the pins of the first port 1220 of the first connector 1210 (e.g., the PCIe connector) may be mapped to and coupled with corresponding pins of the second port 1270 of the second connector 1260, which may be a USB connector or an external Nonvolatile Memory express (NVMe) connector.

When the second connector 1260 of the second memory system 1250 is a USB connector, the second port 1270 includes the second pins 1272, 1274, 1276, 1278 and 1280 for the connection with the first memory system 1200, as described above. For example, the second port 1270 of the second connector 1260, which is the USB connector, may include the second pins 1272, 1274, 1276, 1278 and 1280 as the at least 9 pins C1 to C9, the two ground pins GND, the power pin for power supply, the two reception pins RX− and RX+ for receiving a signal, the two transmitting pins TX− and TX+ for transmitting a signal, the reset pin PERST# for resetting connection, and the clock request pin CLKREQ# for requesting for a clock.

The second memory system 1250 may transmit data at through the second port 1270 of the second connector 1260. For example, the second memory system 1250 may transmit data at a data rate of about 5 Gbps through the second port 1270 of the second connector 1260, when the second connector 1260 is a USB connector. Also, the second port 1270 of the second connector 1260, when the second connector is a USB connector and the first port 1220 of the first PCIe connector 1210, may be synchronized with each other through Separate Reference Clock with Independent Spread Spectrum Clocking Architecture (SRIS), and may be coupled by the third connector 1290 and transmit/receive data to/from each other.

For example, when the first connector 1210 is a PCIe connector and the second connector 1260 is a USB connector then the following pin connections may be made: the power pins A2, A3, A9 and A10 of the first port 1220 of the first connector 1210 may be coupled with the power pin C1, which is a first pin of the second port 1270 of the second connector 1260; the clock request pin of the first port 1220 of the first connector 1210 may be coupled with the clock request pin C2, which is a second pin of the second port 1270 of the second connector 1260; the reset pin A11 of the first port 1220 of the first connector 1210 may be coupled with the reset pin C3 which is a third pin of the second port 1270 of the second connector 1260; the ground pins A4, A12, A15, A18, B4, B7, B13, B16 and B18 of the first port 1220 of the first connector 1210, may be coupled with the ground pins C4 and C7, which are fourth and seventh pins, of the second port 1270 of the second connector 1260; the transmitting pins B14 and B15 of the first port 1220 of the first connector 1210 may be coupled with the transmitting pins C5 and C6, which are fifth and sixth pins of the second port 1270 of the second connector 1260; and the reception pins A16 and A17 of the first port 1220 of the first connector 1210 may be coupled with the reception pins C8 and C9 which are eighth and ninth pins of the second port 1270 of the second connector 1260. The reference clock pins A1 and A14 and the other pins A1, A5, A6, A7, A8, B5, B6, B9, B10, B11, B12 and B17 of the first port 1220 of the first connector 1210 are not coupled with the second port 1270 of the second connector 1260.

When the second connector 1260 of the second memory system 1250 is an external memory device, which may be the external NVMe connector, the second port 1270 includes the second pins 1272 1274, 1276, 1278 and 1280 for the connection with the first memory system 1200, which is described above. For example, the second port 1270 of the second connector 1260, which is the external NVMe connector, may include a plurality of second pins 1272, 1274, 1276, 1278 and 1280, for example at least 12 pins D1 to D12 including three ground pins GND pins for ground connection a power pin for power supply, two reception pins RX− and RX+ for receiving signals, two transmitting pins TX− and TX+ for transmitting signals, a reset pin PERST# for resetting connection, a clock request pin CLKREQ# for requesting for a clock, and two reference clocks REFCLK− and REFCLK+ for the connection with a reference clock.

When the second connector 1260 is an external NVMe connector the memory system 1250 may transmit data at an approximately data rate of about 8 Gbps through the second port 1270. Also, the second port 1270 of the second connector 1260, which is the external NVMe connector, and the first port 1220 of the first connector 1210, which is the PCIe connector, may be synchronized through the reference clocks REFCLK− and REFCLK+, and may be coupled by the third connector 1290 and transmit/receive data to/from each other.

For example, in more detail, when the first connector 1210 is PCIe connector and the second connector is an external NVMe connector the following pin connections may be made: the power pins A2, A3, A9 and A10 of the first port 1220 of the first connector 1210, may be coupled with the power pin D1 which is a first pin of the second port 1270 of the second connector 1260; the clock request pin of the first port 1220 of the first connector 1210 may be coupled with the clock request pin D2 which is a second pin of the second port 1270 of the second connector 1260; the reset pin A11 of the first port 1220 of the first connector 1210 may be coupled with the reset pin D3 which is a third pin of the second port 1270 of the second connector 1260; the ground pins A4, A12, A15, A18, B4, B7, B13, B16 and B18 of the first port 1220 of the first connector 1210 may be coupled with the ground pins D4, D7 and D10 which are fourth, seventh and 10^{th} pins of the second port 1270 of the second connector 1260; the reference clock pins A13 and A14 of the first port 1220 of the first connector 1210, may be coupled with reference clock pins D5 and D6 which are fifth and sixth pins of the second port 1270 of the second connector 1260; the transmitting pins B14 and B15 of the first port 1220 of the first connector 1210 may be coupled with the transmitting pins D8 and D9 which are eighth and ninth pins of the second port 1270 of the second connector 1260; and the reception pins A16 and A17 of the first port 1220 of the first connector 1210 may be coupled with the reception pins D11 and D12 which are 11^{th} and 12^{th} pins of the second port 1270 of the second connector 1260. The other pins A1, A5, A6, A7, A8, B5, 86, B9, B10, B11, B12 and B17 of the first port 1220 of the first connector 1210 are not coupled with the second port 1270 of the second connector 1260.

For example, in an embodiment, power pins A2, A3, A9, A10, B2, B3, B9 and B10 of the first port 1220 of the first connector 1210 are coupled with corresponding power pins C1 and D1 of the second port 1270 of the second connector 1260. Also, a clock request pin of the first port 1220 of the first connector 1210, is coupled with the power pins C2 and D2 of the second port 1270 of the second connector 1260. Ground pins A4, A12, A15, A18, B4, B7, B13, B16 and B18 of the first port 1220 of the first connector 1210 are coupled with ground pins C4, C7, D4, D7 and D10 of the second port 1270 of the second connector 1260. A reset pin A11 of the first port 1220 of the first connector 1210 is coupled with the reset pins C3 and D3 of the second port 1270 of the second connector 1260. The reference clock pins A13 and A14 of the first port 1220 of the first connector 1210 are coupled with the reference clock pins D5 and D6 of the second port 1270 of the second connector 1260. The transmitting pins B14 and B15 of the first port 1220 of the first connector 1210, are coupled with the transmitting pins C5, C6, D8 and D9 of the second port 1270 of the second connector 1260. The reception pins A16 and A17 of the first port 1220 of the first connector 1210 are coupled with the reception pins C8, C9, D11 and D12 of the second port 1270 of the second connector 1260. The other pins A1, A5, A6, A7, A8, B5, B6, B9, B10, B11, B12 and B17 of the first port 1220 of the first connector 1210, are not coupled with the second port 1270 of the second connector 1260.

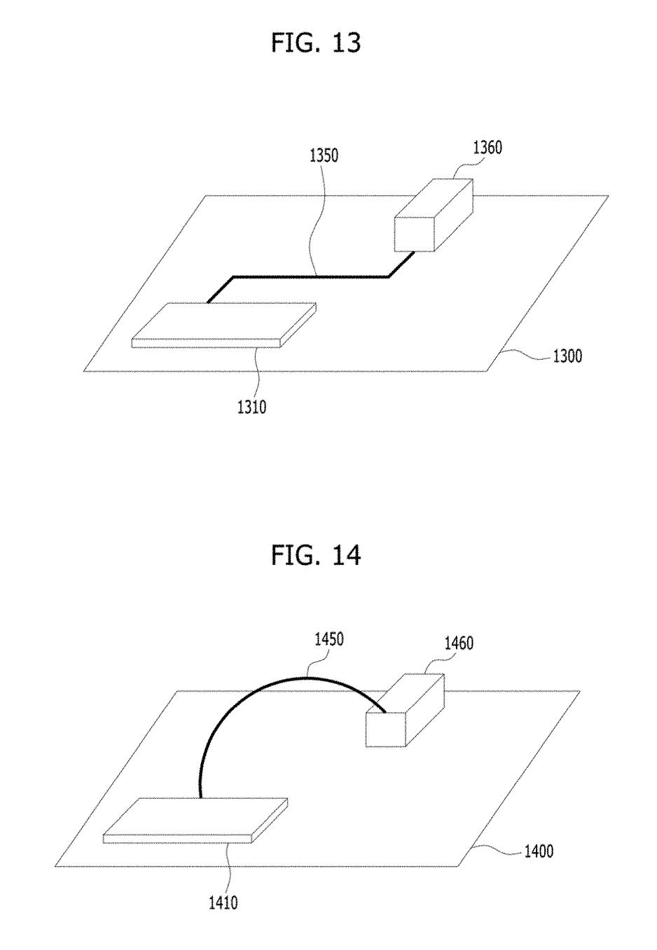

In the data processing system according to the embodiment of the present invention shown in FIG. 13, a first port 1310 included in a first connector of a first memory system and a second port 1360 included in a second connector of a second memory system are implemented on a predetermined board 1300, and they are coupled with each other by a third connector that includes a Printed Circuit Board (PCB) pattern 1350 to transmit/receive data between them.

Also, in the data processing system according to the embodiment of the present invention shown in FIG. 14, a first port 1410 included in a first connector of a first memory system and a second port 1460 included in a second connector of a second memory system are implemented on a predetermined board 1400. They are coupled with each other by a third connector that includes a cable 1450 to transmit/receive data between them.

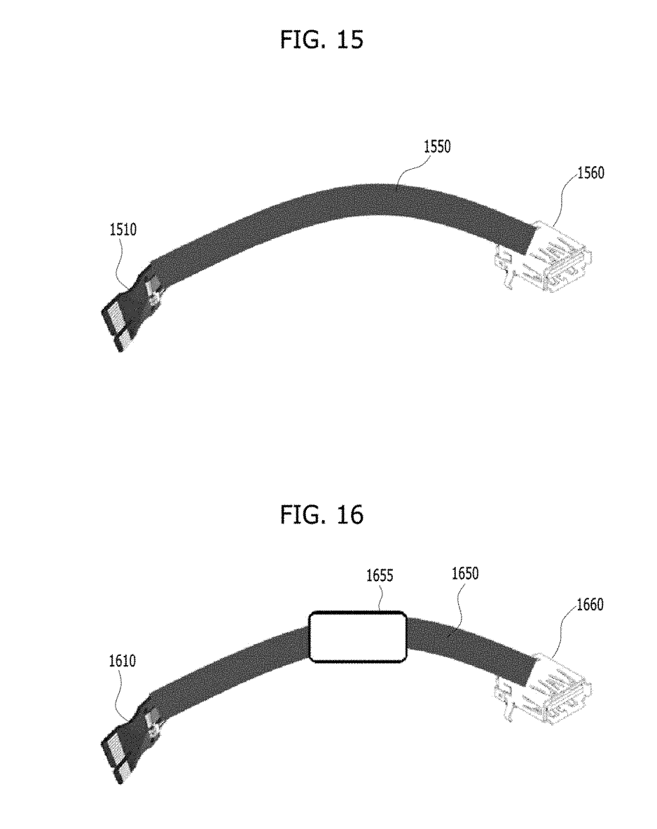

In the data processing system according to the embodiment of the present invention shown in FIG. 15, a first connector 1510 of a first memory system is implemented as a form of a plug and the pins of the first port are mapped to the pins of a second port, as described above. The first connector 1510 may be coupled with a second connector 1560 by a third connector that includes a passive-type cable 1550.

In the data processing system according to the embodiment of the present invention shown in FIG. 16, a first connector 1610 of a first memory system is implemented as a form of a plug and, the pins of the first port are mapped to the pins of a second port, as described above. The first connector 1610 may be coupled with a second connector 1660 by a third connector including an active-type cable 1650 that performs the mapping in an active integrated circuit (IC) 1655.

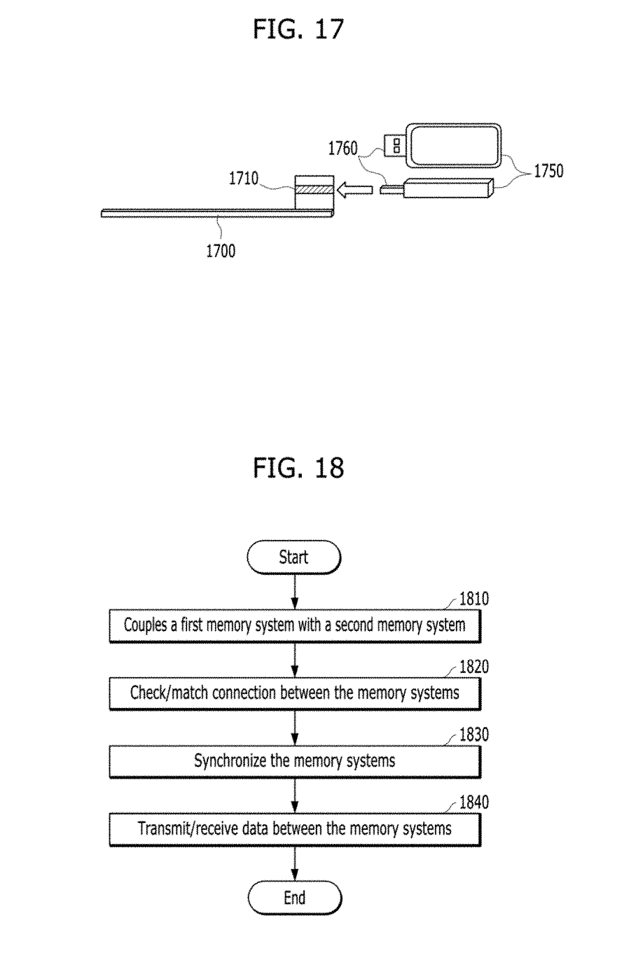

In the data processing system according to the embodiment of the present invention shown in FIG. 17, a second connector 1760 (e.g., USB connector) of a second memory system 1750 may be inserted into a first connector 1710 of a first memory system 1700. The first connector 1710 and the second connector 1760 may be coupled with each other.

Hereafter, an operation of processing data according to an embodiment of the present invention is described in detail with reference to FIG. 18.

FIG. 18 is a flowchart illustrating an operation of processing data in a data processing system, according to an embodiment of the present invention.

Referring to FIG. 18, in step S1810, the data processing system couples a first memory system with a second memory system. The first memory system may include the memory device 150 and the controller 130 shown in FIG. 1 that is coupled with the host 102. The second memory system may include the memory device 150 shown in FIG. 1 or include the memory device 150 and, the controller 130 shown in FIG. 1. The second memory system may also be coupled with the host 102.

In step S1820, the method for coupling the first memory system and the second memory system is checked out, and the first memory system and the second memory system are matched.

In step S1830, the first memory system and the second memory system are synchronized to transmit/receive data between the first memory system and the second memory system.

In step S1840, data are transmitted/received between the first memory system and the second memory system. In other words, the data stored in the first memory system are transmitted to the second memory system and then the second memory system processes the data. Also, the data stored in the second memory system are transmitted to the first memory system and then the first memory system processes the data.

Data processing in the data processing system according to an embodiment of the present invention, for example, the structure of the data processing system, specifically the structures of the first memory system and the second memory system included in the data processing system, and the coupling between the first memory system and the second memory system, is described above in detail with reference to FIGS. 12 to 17, further description on it is not provided herein.

The data processing system and the method for operating the data processing system according to the embodiment of the present invention may minimize complexity and performance degradation of the memory systems and process data exchanged among the memory systems stably and rapidly.

While the present invention has been described with respect to the specific embodiments, it will be apparent to those skilled in t he art that various changes and modifications may be made without departing from the spirit and scope of the invention as defined in the following claims.

What is claimed is:

1. A data processing system, comprising:
first memory system including a first memory device and a first controller for controlling the first memory device;
a second memory system including a second memory device;
a first connector suitable for supporting the first memory system to be coupled with the second memory system through a first connection method;
a second connector suitable for supporting the second memory system to be coupled with the first memory system through a second connection method; and
a third connector that couples the first system and the second memory system with each other.

2. The data processing system of claim 1, wherein the first connector is coupled with a host of the first memory system, and
the first connector includes a first port including a plurality of first pins for connection with the second memory system.

3. The data processing system of claim 2, wherein the second connector includes a second port including a plurality of second pins for connection with the first memory system.

4. The data processing system of claim 3, wherein the first port is coupled with the second port through mapping between the first pins and the second pins, and
the first pins transmit/receive sign to/from the second pins through the third connector.

5. The data processing system of claim 4, wherein power pins, ground pins, transmitting pins, reception pins, clock pins, and reset pins of the first pins are mapped to the corresponding power pins, ground pins, transmitting pins, reception pins, clock pins, and reset pins of the second pins.

6. The data processing system of claim 4, wherein as reference clock pins of the first pins are mapped to reference clock pins of the second pins, the first port and the second port are synchronized.

7. The data processing system of claim 1, wherein the first connector is peripheral Peripheral Component Interconnection express (PCIe) connector.

8. The data processing system of claim 1, wherein the second connector is at least one of a Universal Serial Bus (USB) connector and an external Nonvolatile Memory express (NVMe) connector.

9. The data processing system of claim 1, wherein the third connector includes a Printed Circuit Board (PCB) pattern or cable; and
the cable is one between a passive-type cable and an active-type cable including an active Integrated Circuit (IC).

10. The data processing system of claim 1, wherein the second connector is inserted into the first connector, and the first memory system and the second memory system are coupled with each other.

11. The data processing system of claim 1, wherein the second memory system further includes:
a second controller for controlling the second memory device.

12. A method for operating a data processing system, comprising:
coupling a first memory system including a first memory device and a first controller for controlling the first memory device, with a second memory system including a second memory device, through a transmit connector;
checking a first connection method of the first memory system and a second connection method of the second memory system;
coupling a first connector having the first connection method with a second connector having the second connection method; and
transmitting data stored in the first memory system to the second memory system, transmitting data stored in the second memory system to the first memory system, and processing the data transmitted from the first memory system and the second memory system.

13. The method of claim 12, wherein the first connector is coupled with a host of the first memory system, and
the first connector includes a first port including a plurality of first pins for connection with the second memory system.

14. The method of claim 13, wherein the second connector includes a second port including a plurality of second pins for connection with the first memory system.

15. The method of claim 14, wherein in the coupling of the first connector having the first connection method with the second connector having the second connection method, the first port and the second port are coupled with each other through mapping between the first pins and the second pins; and
in the transmitting of the data stored in the first memory system to the second memory system, the transmitting of the data stored in the second memory system to the first memory system, and the processing of the data transmitted from the first memory system and the second memory system, the first pins and the second pins transmit/receive signals through the transmit connector.

16. The method of claim 15, wherein power pins, ground pins, transmitting pins, reception pins, dock pins, and reset pins of the first pins are mapped to the corresponding power pins, ground pins, transmitting pins, reception pins, dock pins, and reset pins of the second pins.

17. The method of claim 15, wherein as reference clock pins of the first pins are mapped to reference clock pins of the second pins, the first port and the second port are synchronized.

18. The method of claim 12, wherein the first connector is a Peripheral Component Interconnection express (PCIe) connector.

19. The method of claim 12, wherein the second connector is at least one of a Universal Serial Bus (USB) connector and an external Non-Volatile Memory express (NVMe) connector.

20. The method of claim 12, wherein the transmit connector includes a Printed circuit Board (PCB) pattern or cable, and
the cable is one between a passive-type cable and an active-type cable including an active Integrated Circuit (IC).
